(19) United States
(12) Patent Application Publication
(10) Pub. No.: US 2002/0071444 A1
(43) Pub. Date: Jun. 13, 2002

(54) Method and system for setting up weighted communication links

(76) Inventor: Alexander Aschir, Bangalore (IN)

Correspondence Address: BELL, BOYD & LLOYD, LLC, P. O. BOX 1135, CHICAGO, IL, 60690-1135, US

(21) Appl. No.: 09/940,814

(22) Filed: Aug. 27, 2001

(30) Foreign Application Priority Data
Aug. 25, 2000 (DE) 100 43 264.6

(51) Int. Cl. H04J 3/16

(52) U.S. Cl. 370/437; 370/462

(57) ABSTRACT

A method and system for setting up a communication link in a communication network from a communication terminal to a destination communication terminal, in which the communication link is allocated a weighting, and an already existing old communication link to the destination communication terminal is interrupted and the communication link from the communication terminal to the destination communication terminal is set up if the communication link has a higher weighting than the old communication link. To improve the setting up of weighted communication links, while the communication link is being set up, the weighting thereof is changed by the network if the communication link needs to be operated with either lower priority or higher priority.

### BACKGROUND OF THE INVENTION

The present invention relates to a method and system for setting up a communication link in a communication network from a communication terminal to a destination communication terminal, in which the communication link is allocated a weighting, and an already existing old communication link to the destination communication terminal is interrupted and the communication link from the communication terminal to the destination communication terminal is set up if the communication link has a higher weighting than the old communication link. Within the context of the present invention, “setting up” a communication link is understood as meaning both setting up the communication link and continuing (operating, maintaining) the communication link. Such a method is known from the printed document “GSM 02.67 Digital cellular telecommunications system (Phase 2+); enhanced Multi-Level Precedence and Pre-emption service (eMLPP)—Stage 1 (GSM 02.67)” Version 5.0.1 of July 1996 from the organization ETSI (European Telecommunications Standards Institute), particularly from page 12, sections 5.8 and 5.9.

In this method, weightings (also called priority levels) are given to communication links (calls). Communication links having a relatively high weighting (priority levels) can interrupt existing calls having a lower weighting. This method eMLPP is used in mobile radio networks. A similar method, called “MLPP” (“Multi-Level Precedence and Pre-emption service”), is used in cable-connected networks.

The present invention is directed toward specifying a method and a system which are used to improve the setting up of weighted communication links.

### SUMMARY OF THE INVENTION

The present invention includes the feature that, in a method of the aforementioned type, while the communication link is being set up, the weighting thereof is changed by the network if the communication link needs to be set up with lower priority or with higher priority with respect to the first-allocated weighting. In this context, a particular advantage is that the weighting of the communication link can be changed even if it is not until after the weighting has been allocated; for example, that it is detected that the communication link needs to be set up with higher priority or with lower priority.

The inventive method can be configured such that a destination address for the communication link is used to detect whether the communication link needs to be set up with lower priority or with higher priority. This is advantageous because it easily can be detected from the destination address for the communication link whether the communication link needs to be set up with lower priority or with higher priority. Thus, by way of example, communication links having distinguished destination addresses may need to be set up with higher priority and communication links having other distinguished destination addresses may need to be set up with lower priority.

The inventive method also can be configured such that the weighting of the communication link is increased if the communication link needs to be set up with higher priority. Increasing the weighting allows the communication link to be set up with higher priority.

The inventive method also can be configured such that the weighting of the communication link is reduced if the communication link needs to be set up with lower priority. Reducing the weighting of the communication link allows this communication link to be set up with lower priority, so that any already existing communication links can be terminated without being influenced.

The inventive method also can be configured such that a destination address, appearing in a number plan for the communication network, for the communication link is used to detect whether the communication link needs to be set up with lower priority or with higher priority. In this context, a particular advantage is that—since, in such number plans, arbitrary destination addresses may be part of communication links which need to be set up with higher priority, for example—the weighting of communication links can be changed on the basis of their allocation when these number plans are used. Such number plans can be, for example, “private number plans” which are typically used in companies for the purpose of communication suited to the company structure.

The inventive method also can be configured such that the weighting of the communication link is increased if the communication link is detected to be an emergency call. This allows emergency calls to be set up particularly quickly, since any existing old communication links can be interrupted in the event of an emergency call arising.

The inventive method also can be configured such that an intelligent node of a communication network having a structure of an Intelligent Network (IN) detects whether the communication link needs to be set up with lower priority or with higher priority. This is advantageous because intelligent networks can be used to produce, relatively quickly and easily, services such as the inventive method which extend the functionality of communication networks.

The inventive method also can be configured such that the change to the weighting is notified by the intelligent node to a service switching point of the communication network using an extended INAP message “Connect”. An advantage, in this case, is that the change to the weighting can be notified merely by extending the “Connect” message, and no additional new message need be used.

A system for carrying out the inventive method has detection capabilities for detecting whether a communication link needs to be set up with lower priority or with higher priority, and changing capabilities for changing the weighting of the communication link. This inventive system has the particular advantage that when the system detects a lower-priority status or a higher-priority status of the communication link, the system can change the weighting of the communication link.

The inventive system also can be configured such that the detection part detects from a destination address for the communication link whether the communication link needs to be set up with lower priority or with higher priority. In this case, a particular advantage is that the lower-priority status or higher-priority status of a communication link often can be easily detected from the destination address if distinguished destination addresses have had a lower-priority status or a higher-priority status allocated to them.

The inventive system also can be configured such that the detection part has an intelligent node of a communication network having a structure of an Intelligent Network (IN). Intelligent nodes in intelligent networks advantageously can be used as detection parts because they can be quickly and easily matched to different tasks.

The inventive system also can be configured such that the changing part has an intelligent node of a communication network having a structure of an Intelligent Network (IN). In this context, by way of example, the intelligent node already used as the detection part advantageously may be used as the changing part.

The inventive system may have, likewise as the changing part, a service switching point of the communication network.

Additional features and advantages of the present invention are described in, and will be apparent from, the following Detailed Description of the Invention and the figures.

### BRIEF DESCRIPTION OF THE FIGURES

FIG. 1 shows, as an exemplary embodiment of the present invention, a detail from a communication network having a communication terminal and a destination communication terminal.

FIG. 2 shows, as another exemplary embodiment of the present invention, a detail from a cable-connected communication network having a communication terminal and a destination communication terminal.

### DETAILED DESCRIPTION OF THE INVENTION

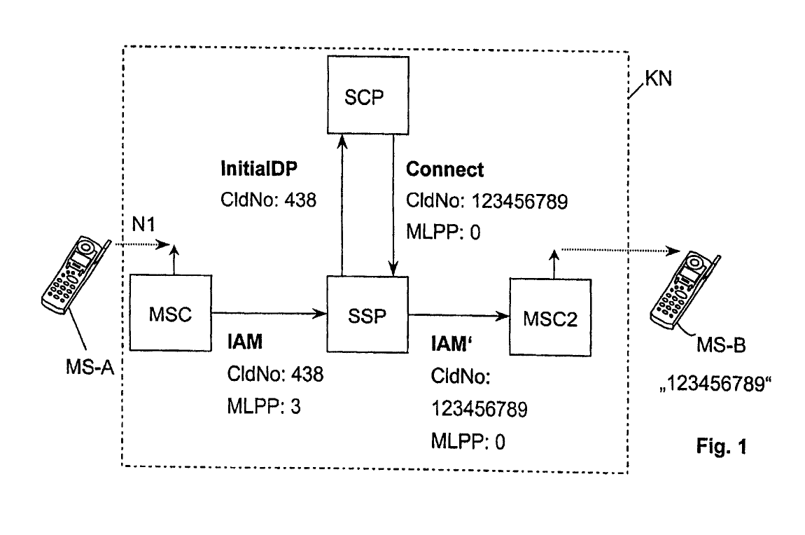

The communication network KN shown as a detail in FIG. 1 is a radio communication network (mobile radio network) in the exemplary embodiment.

A communication terminal MS-A has a maximum weighting assigned to it at least intermittently. If a communication link is set up (a call is set up) from this communication terminal MS-A, the communication link is allocated a weighting which is lower than or the same as the maximum weighting. The communication terminal MS-A, which is shown by a mobile telephone in the exemplary embodiment, dials a destination address “438”, which is valid within a private number plan, for example. Such a private number plan is used in companies, for example, which set up and catalog their destination addresses (e.g., their telephone numbers) on the basis of rules valid within the company. Such private number plans exist for railway companies or police organizations, for example. Table 1 shows a detail from a telephone number plan used by European railways, for example, as part of the “GSM-Railway” system. This table shows that the destination address “438” is an emergency telephone number (“Railway Emergency Calls”).

Table 2 shows, as a detail, an exemplary embodiment of allocations of weightings (“Priority level”) to various communication link types (cf. the aforementioned standard “GSM 02.67” p. 10). The weightings 4 to 0 are allocated for communication links by users of the eMLPP method, where the weighting 4 has the least weight (the lowest priority) and the weighting 0 has the greatest weight (the highest priority). In this example, the weighting 0 is used for emergency communication links (“TS12 Emergency calls”).

In FIG. 1, upon the destination address “438” being dialed, a message N1 is sent in a known manner to a mobile switching center MSC using a radio transmission link. In this example, the communication terminal MS-A has had a maximum weighting of level 3 allocated to it. Accordingly, the communication link (the call) originating from the communication terminal MS-A is allocated a weighting of level 3 which, in this illustrative case, corresponds to the level of the maximum weighting. The message N1 is used to transmit the weighting 3 and the destination address, among other things, to the mobile switching center MSC.

The mobile switching center MSC then sends a message IAM to a service switching point SSP. The message IAM (“Initial Address Message”) contains, among other things, the dialed destination address “438” as “called number” parameter (“CldNo”) and the weighting “3” as “MLPP” parameter. The service switching point SSP detects from the destination address “CldNo” that this communication link is an emergency call, because the destination address “438” has had an emergency call function assigned to it in the private number plan.

The service switching point SSP then sends an “InitialDP” (Initial Detection Point) message to an intelligent node SCP. The “InitialDP” message and the “Connect” message, which is used further below in this exemplary embodiment, are described, by way of example, in the printed document “ETS 300 374-1 Intelligent Network (IN); Intelligent Network Capability Set 1 (CS 1); Core Intelligent Network Application Protocol (INAP); Part 1: Protocol specification” of September 1994 from the organization “ETSI”. The “InitialDP” message contains the destination address “438” as “CldNo” parameter; it can also contain the weighting “3” (not shown in FIG. 1). The intelligent node SCP reads, for example from a database (not shown in FIG. 1), which communication terminal has been allocated to the emergency call destination address “438” at the relevant time. In this example, the emergency destination address “438” has an associated mobile communication terminal MS-B having a destination address “123456789”.

It should be pointed out at this juncture that the emergency destination address “438” naturally also can have an associated mobile communication terminal MS-B having a destination address “438”; in this case, the destination address would not change. However, it is often advantageous to allocate various destination addresses for communication terminals to an unchanging emergency destination address, for example, on the basis of the time and place of the communication (e.g., an emergency call arising at the weekend then can be directed to a different receiver than an emergency call arising on a work day). Likewise, it may be advantageous to use, instead of a destination address which is difficult to memorize for a communication terminal (“123456789”), a destination address which is easier to memorize (“438”) for emergency calls.

In this exemplary embodiment, after allocation of the destination address “123456789”, the intelligent node SCP returns a “Connect” message to the service switching point SSP. This “Connect” message contains the destination address “123456789” of the destination communication terminal MS-B as “CldNo” parameter. Since the intelligent node SCP has detected that the communication link is an emergency call, this connection is allocated the high weighting “0” so that the connection can be set up with higher priority. The “Connect” message, therefore, contains the weighting “0” as further additional parameter “MLPP”. After reception of the “Connect” message, the service switching point SSP then overwrites the content of the “CldNo” parameter in the message IAM received from the mobile switching center MSC with the destination address “123456789” of the destination communication terminal MS-B. It likewise overwrites the content of the MLPP parameter with the weighting “0”. The altered message IAM′ is then sent by the service switching point SSP to the second mobile switching center MSC2. From this second switching center MSC2, the communication link is set up to the destination communication terminal MS-B in a known manner using a radio channel. If, at this time, there already is an existing old communication link from another communication terminal (not shown in FIG. 1) to the destination communication terminal MS-B, and should this old communication link have a lower weighting than the weighting 0 of the communication link (emergency call), then the old communication link to the destination communication terminal MS-B is interrupted and the communication link (emergency call) is set up.

FIG. 1 shows a detail from a mobile communication network as an exemplary embodiment. The present inventive method and system are not limited to mobile communication networks, however. Cable-connected communication networks also may be used.

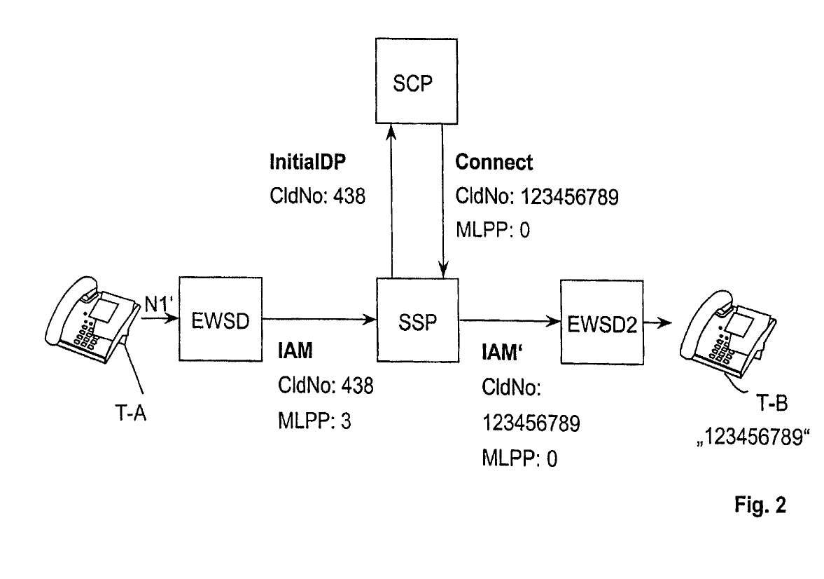

FIG. 2 shows a detail from a cable-connected communication network. Unlike in FIG. 1, a switching center EWSD is arranged instead of the mobile switching center MSC, and a second switching center EWSD2 is arranged instead of the second mobile switching center MSC2. Accordingly, cable-connected communication terminals T-A (Telephone A) and T-B (Telephone B) are used. Otherwise, the method corresponds to the method illustrated in connection with FIG. 1 and the system corresponds to the system illustrated in FIG. 1. The chosen weightings (“Priority level”) should be understood merely as examples; they also may assume values other than those in the exemplary embodiments.

Although the present invention has been described with reference to specific embodiments, those of skill in the art will recognize that changes can be made thereto without departing from the spirit and scope of the invention as set forth in the hereafter appended claims.

TABLE 1

| | 0 | International public | | | Access to public network |
|---|---|---|---|---|---|
| | | Number (E.164) | | | |
| 1 | 0 | | | | Railway Gateway |
| | | | | | (private numbering pl.) |
| | 1 | 1 | 2 | International short | Reserved (mobile |
| | | | | dialling codes | emergency number) |
| | 2 | X | X | | Route to most |
| | | | | | appropriate controller (in |
| | | | | | case of failure of |
| | | | | | addressing) |
| | 3 | X | X | | Route to most |
| | | | | | appropriate ETCS RBC |
| | 4 | 3 | 8 | | Railway Emergency |
| | | | | | Calls |
| | | | 9 | | Railway emergency |
| | | | | | calls/broadcast |
| | | | | | acknowledge |
| | 5 | 5 | 5 | | Railway emergency |
| | | | | | broadcast |
| | 6 | 2 | 7 | | Shunting emergency call |
| | | | 8 | | Shunting emergency call |
| | | | | | acknowledge |
| | 7 | 1 | 1 | | Call from cab driver to |
| | | | | | primary controller |
| | | | 2 | | Call from cab driver to |
| | | | | | secondary control. |
| | | | 3 | | Call from cab driver to |
| | | | | | electricity controller |

| 2 | Running number | 0 | 0 | Running No - Emergency |
|---|---|---|---|---|
| | | | | Call |
| | 11 XXXXXX - six significant | | 1 | leading driver |
| | numbers | | | |
| | 2 XXXXXXX - seven | | 2- | other driver |
| | significant numbers | | 5 | |
| | yXXXXXXX - eight | | 6 | fax or alternate fax/ |
| | significant numbers | | | speech |

TABLE 2

| Weighting | |
|---|---|
| (priority level) | Communication Connection Example |
| 0 | Emergency call |
| 1 | Premium Rate Call |
| 2 | Normal Rate Call |
| 3 | Standard Pre-adjustment |
| 4 | Inexpensive Rate Call |

The invention is claimed as follows:

1. A method for setting up a communication link in a communication network from a communication terminal to a destination communication terminal, the method comprising the steps of:
allocating a weighting to the communication link;
determining if the communication link has a higher weighting than an already existing old communication link to the destination communication terminal;
interrupting the old communication link and setting up the communication link from the communication terminal to the destination communication terminal if the communication link has a higher weighting than the old communication link; and
changing the weighting, while the communication link is being set up, via the communication network if the communication link needs to be set up with a different priority with respect to the allocated weighting, the different priority being one of a higher priority and a lower priority.

2. A method for setting up a communication link in a communication network from a communication terminal to a destination communication terminal as claimed in claim 1, the method further comprising the step of:
using a destination address for the communication link to detect whether the communication link needs to be set up with the different priority.

3. A method for setting up a communication link in a communication network from a communication terminal to a destination communication terminal as claimed in claim 1, the method further comprising the step of:
increasing the weighting of the communication link if the communication link needs to be set up with a higher priority.

4. A method for setting up a communication link in a communication network from a communication terminal to a destination communication terminal as claimed in claim 1, the method further comprising the step of:
reducing the weighting of the communication link if the communication link needs to be set up with a lower priority.

5. A method for setting up a communication link in a communication network from a communication terminal to a destination communication terminal as claimed in claim 2, wherein the destination address appears in a number plan for the communication network.

6. A method for setting up a communication link in a communication network from a communication terminal to a destination communication terminal as claimed in claim 2, wherein the weighting of the communication link is increased if the communication link is detected to be an emergency call.

7. A method for setting up a communication link in a communication network from a communication terminal to a destination communication terminal as claimed in claim 1, wherein the communication network is an Intelligent Network, and an intelligent node of the Intelligent Network detects whether the communication link needs to be set up with a different priority.

8. A method for setting up a communication link in a communication network from a communication terminal to a destination communication terminal as claimed in claim 1, wherein the communication network is an Intelligent Network, and the weighting is changed by an intelligent node of the Intelligent Network.

9. A method for setting up a communication link in a communication network from a communication terminal to a destination communication terminal as claimed in claim 8, the method further comprising the step of:
notifying the change to the weighting by the intelligent node to a service switching point of the Intelligent Network using an extended INAP message.

10. A system for setting up a communication link in a communication network from a communication terminal to a destination communication terminal, wherein the communication link is allocated a weighting, and an already existing old communication link to the destination communication terminal is interrupted and the communication link from the communication terminal to the destination communication terminal is set up if the communication link has a higher weighting than the old communication link, the system comprising a detection part for detecting whether the communication link needs to be set up with a different priority with respect to the allocated weighting, the different priority being one of a higher priority and a lower priority, and further comprising a changing part for changing the weighting of the communication link if the communication needs to be set up with the different priority.

11. A system for setting up a communication link in a communication network from a communication terminal to a destination communication terminal as claimed in claim 10, wherein the detection part detects from a destination address for the communication link whether the communication link needs to be set up with the different priority.

12. A system for setting up a communication link in a communication network from a communication terminal to a destination communication terminal as claimed in claim 10, wherein the communication network is an Intelligent Network, and the detection part includes an intelligent node of the Intelligent Network.

13. A system for setting up a communication link in a communication network from a communication terminal to a destination communication terminal as claimed in claim 10, wherein the communication network is an Intelligent Network, and the changing part includes an intelligent node of the Intelligent Network.

14. A system for setting up a communication link in a communication network from a communication terminal to a destination communication terminal as claimed in claim 10, wherein the changing part includes a service switching point of the communication network.
